(19) United States
(12) Patent Application Publication
(10) Pub. No.: US 2006/0012463 A1
(43) Pub. Date: Jan. 19, 2006

(54) Local 2-way paging systems and associated methods

(76) Inventors: Richard Sharpe, Woodbridge, IL (US); James Poulos, Northbrook, IL (US)

Correspondence Address: LATHROP & GAGE LC, 4845 PEARL EAST CIRCLE, SUITE 300, BOULDER, CO, 80301, US

(21) Appl. No.: 11/182,136

(22) Filed: Jul. 15, 2005

Related U.S. Application Data
(60) Provisional application No. 60/588,177, filed on Jul. 15, 2004.

(51) Int. Cl. H04Q 7/00

(52) U.S. Cl. 340/7.21; 340/7.55; 340/7.63

(57) ABSTRACT

Systems and methods for 2-way paging are disclosed. A 2-way pager ceiver for transmitting a sent page and for receiving a received page, and a or displaying information of the received page and for inputting information of The pager also includes memory configured to store a list of pagee IDs and a es; and a processor. The processor responds to the user interface and the associates a selected pagee ID with a selected page code to compose the sent page.

### CROSS-REFERENCE TO RELATED APPLICATIONS

This application claims benefit of priority to U.S. Provisional Patent Application No. 60/588,177, filed 15 Jul. 2004, which is incorporated herein by reference to the same extent as though fully replicated herein.

### BACKGROUND

Paging systems are used in a variety of applications such as TV and radio transmission, cellular/PCS communications, and pager services. In association with wide area networks, existing pager repeaters typically only provide one-way communication. By way of example, a base station antenna typically transmits a signal to a pager, sometimes utilizing tower-mounted repeaters. The signal may contain a return phone number for reaching the person who is calling the pager.

Paging systems that cover broad geographic areas typically employ sophisticated networks of repeaters mounted on transmission towers. Tower-mounted repeater systems are often used to extend the range of a base station and to fill nulls in the coverage area of the base station. These paging systems generally include: a link antenna that is directed/aimed at a base station antenna; repeater electronics; and a broadcast antenna that is directed towards the area of interest. Often, the link antenna is highly directional, with high gain and a very narrow beam because it only needs to “see” the base station antenna. The broadcast antenna has a wider beam, to cover the intended area. Thus, traditional pager repeaters only provide for one-way communication with the pager and do not transmit signals to the base station antenna.

One recent advance provides pagers that allow two way communications; i.e., the pager also transmits signals. Thus, additional full base station antennas are required to provide two-way pager coverage over large areas. This is because full base stations are required to send and receive pager signals over large areas, as compared to the capability of highly directional link antennas. However, full base station antennas are costly to construct and expensive to maintain.

Typical paging systems require a user to enter full information of a text message, resulting in user interfaces wherein a user may be faced with options such as using more than one key to enter a letter (e.g., keys of a telephone keypad) or must use a keyboard that has a key for each letter (e.g., a “qwerty” keyboard), which may form an inconveniently large keyboard or inconveniently small keys.

### SUMMARY OF THE INVENTION

A pager that is capable of two-way communications (a “2-way pager”) overcomes the problems outlined above and advances the art by operating on a local network of 2-way pagers. In one embodiment, the 2-way pager operates within a local network of 2-way pagers for office or commercial use. Each 2-way pager is configured to use the local network by setting the network ID on configuration switches (e.g., DIP switches) within the pager. Pagers thus only communicate with other pagers having the same network ID.

In one embodiment, a 2-way pager includes a transceiver for transmitting a sent page and for receiving a received page, and a user interface for displaying information of the received page and for inputting information of the sent page. The pager also includes memory configured to store a list of pagee IDs and a list of page codes; and a processor. The processor responds to the user interface and the memory, and associates a selected pagee ID with a selected page code to compose the sent page.

In one embodiment, a method of two-way paging includes accepting a key sequence to compose information of a page on a first pager, and sending the page from the first pager to a second pager. The page includes information of a network ID, a pager ID, a pagee ID and a page code. The method includes the second pager receiving the page, validating that the second pager is configured for the network ID of the page, and sending a confirmation from the second pager to the first pager to confirm that the page was received.

In one embodiment, a software product includes instructions that when executed by a computer, perform steps for two-way paging. The steps include accepting a key sequence to compose information of a page on a first pager, and sending the page from the first pager to a second pager. The page includes information of a network ID, a pager ID, a pagee ID and a page code. The method includes the second pager receiving the page, validating that the second pager is configured for the network ID of the page, and sending a confirmation from the second pager to the first pager to confirm that the page was received.

### BRIEF DESCRIPTION OF THE DRAWINGS

FIG. 1 shows a block schematic diagram of one 2-way pager.

FIG. 2A shows a front view of one 2-way pager.

FIG. 2B shows a back view of one 2-way pager.

FIG. 3 illustrates a local network, showing how 2-way pagers may communicate with each other.

FIG. 4 is a flowchart of one exemplary process of 2-way paging.

FIG. 5 is a flowchart of a learn mode of a 2-way pager.

FIG. 6 is a flowchart of a repeater mode of a 2-way pager.

FIG. 7 is a flowchart of a send page mode of a 2-way pager.

FIG. 8 is a flowchart of a receive page mode of a 2-way pager.

### DETAILED DESCRIPTION OF THE DRAWINGS

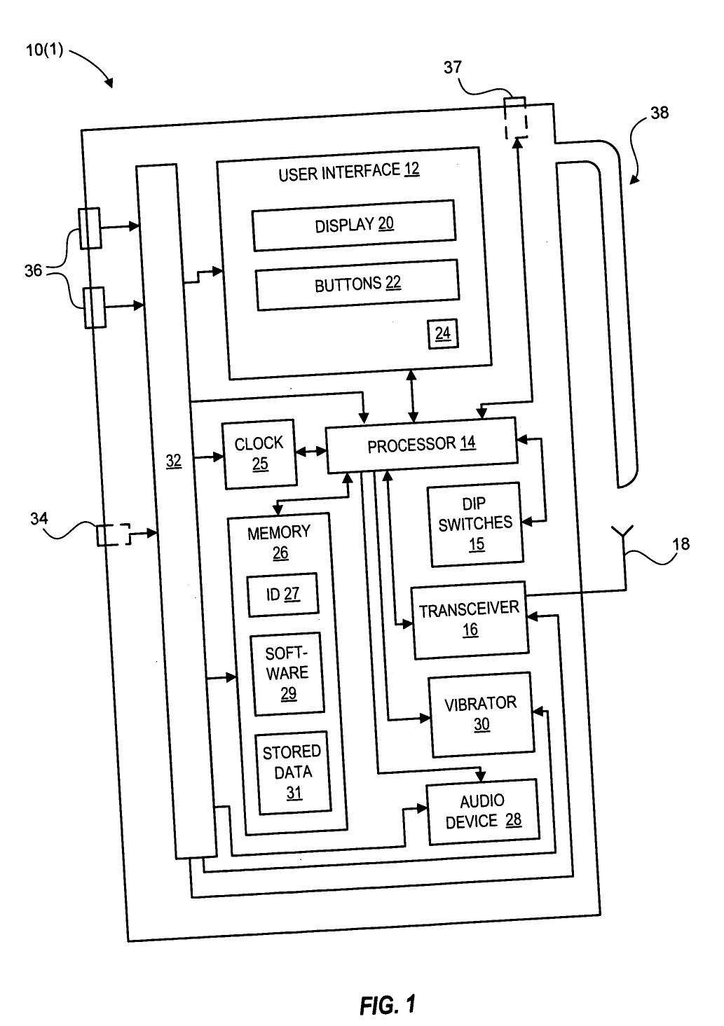

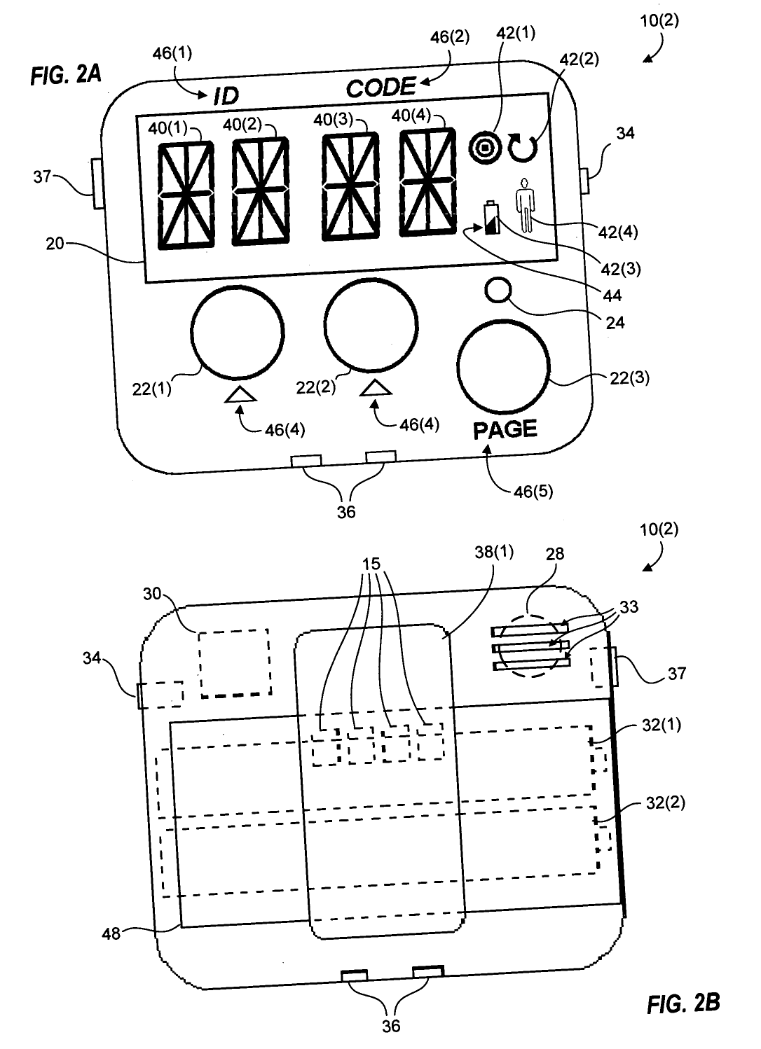

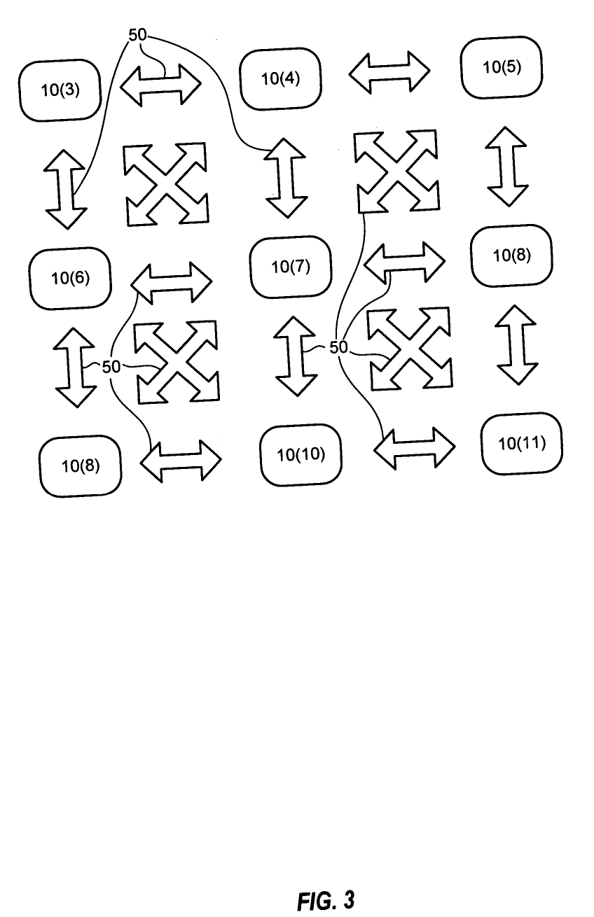

FIG. 1 shows a block schematic diagram of one 2-way pager 10(1). Pager 10(1) has a user interface 12 that responds to user input for managing, displaying and/or sending information. For example, user interface 12 has buttons 22 that a user may press to set up and/or send a page to another pager, or that the user may press to display and/or acknowledge a received page. User interface 12 also includes a display 20 that can display numeric, alphanumeric and/or graphical symbols to the user (see FIG. 3). An optional indicator 24 (e.g., page received confirmation indicator 24, FIG. 2) may, for example, indicate when a page sent from pager 10(1) is acknowledged. In an alternate embodiment, indicator 24 may be incorporated into display 12.

A processor 14 executes software 29 that may be stored in a memory 26 to control implementation of the functions described herein by pager 10(1); it is appreciated that processor 14 and memory 26 may be discrete components or may reside within a single component. Memory 26 may be, for example, nonvolatile memory. Pager 10(1) optionally includes a clock 25 (e.g., a real time clock chip) in communication with processor 14; clock 25 provides time and/or date information that may be displayed on display 20 and/or included in information of pages (e.g., sent and/or received pages) by processor 14. It is appreciated that memory 26 and/or clock 25 may be separate components from processor 14, or they may be integrated (e.g., in a single microchip). In addition to holding software 29, memory 26 may also hold an identification code (“ID”) 27 that is assigned to pager 10(1), and stored data 31 that may include, for example, lists of pages received, IDs of pagees within a network of pager 10(1), and codes representing page code used within the network, as described in more detail below.

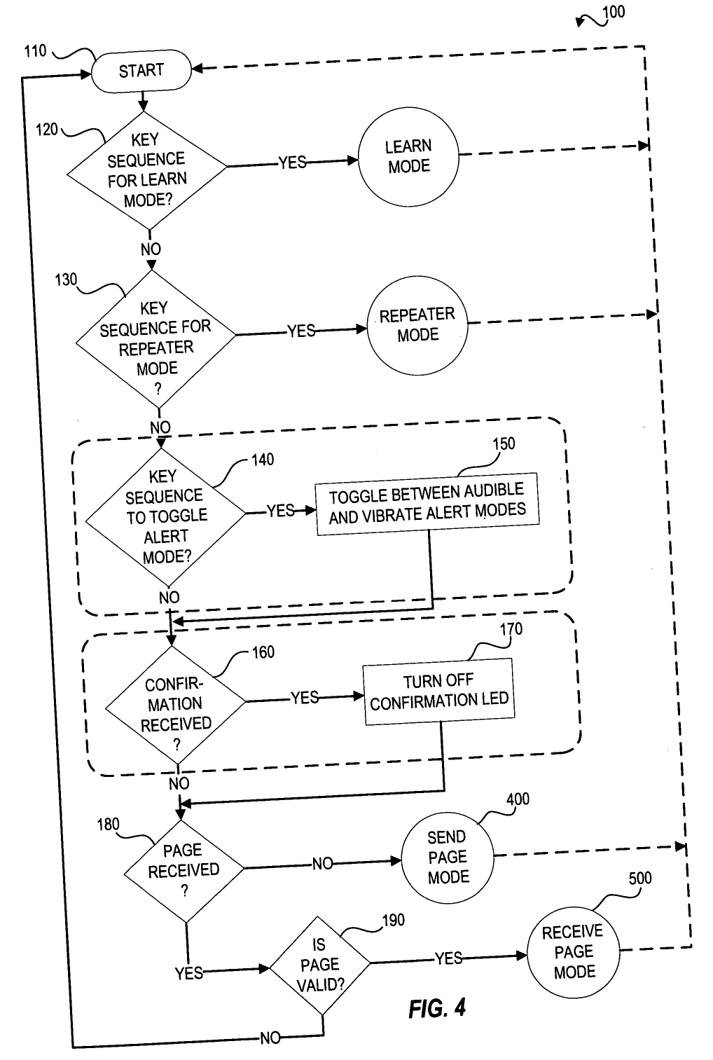

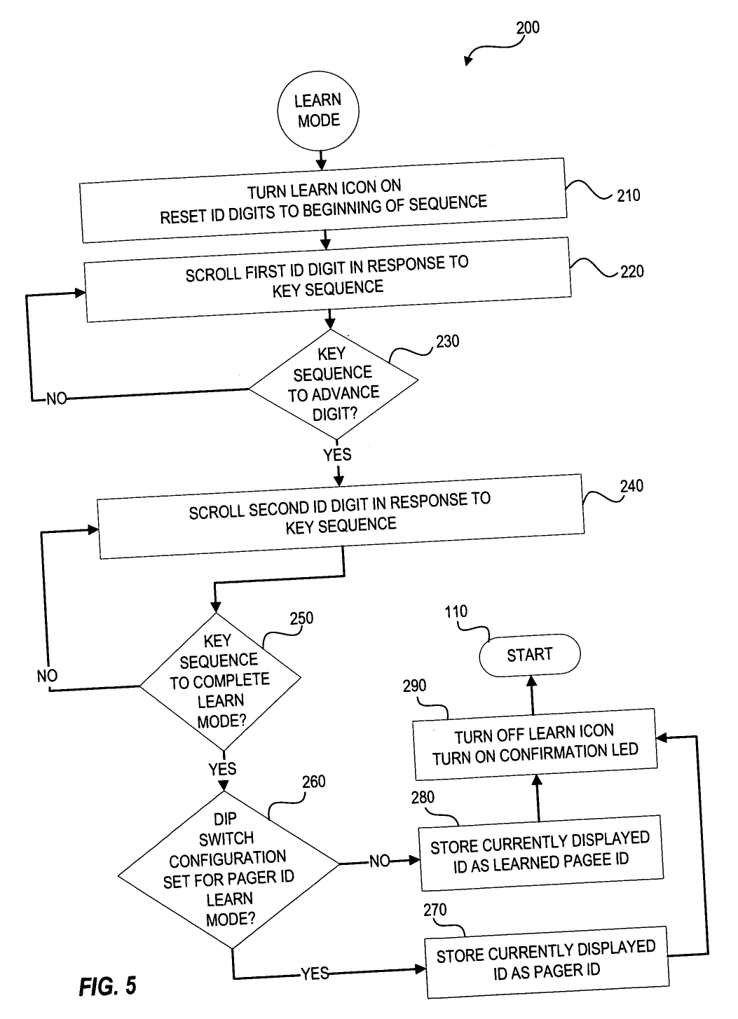

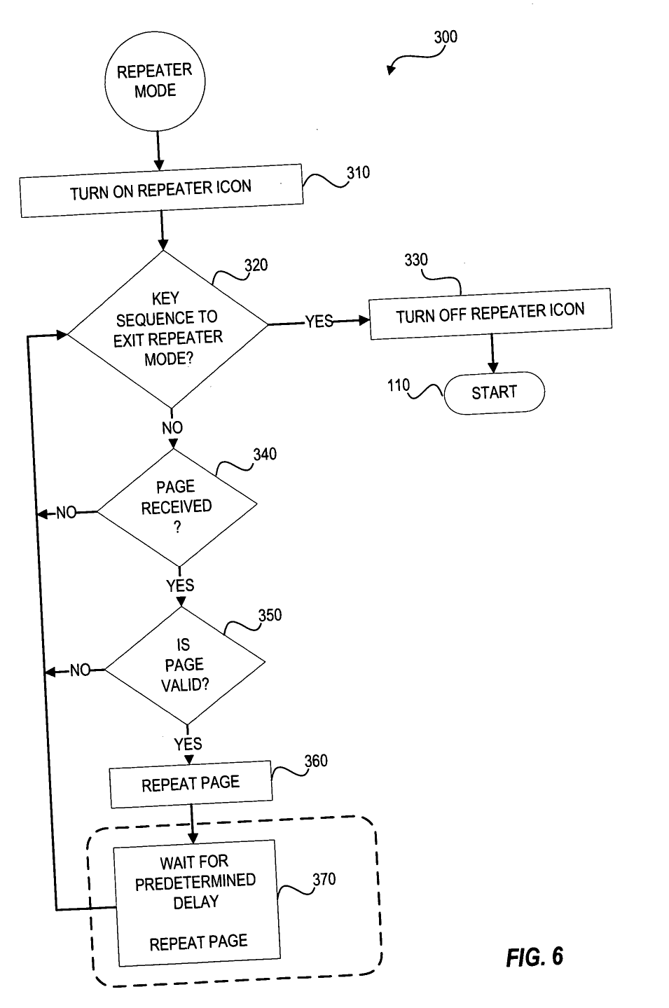

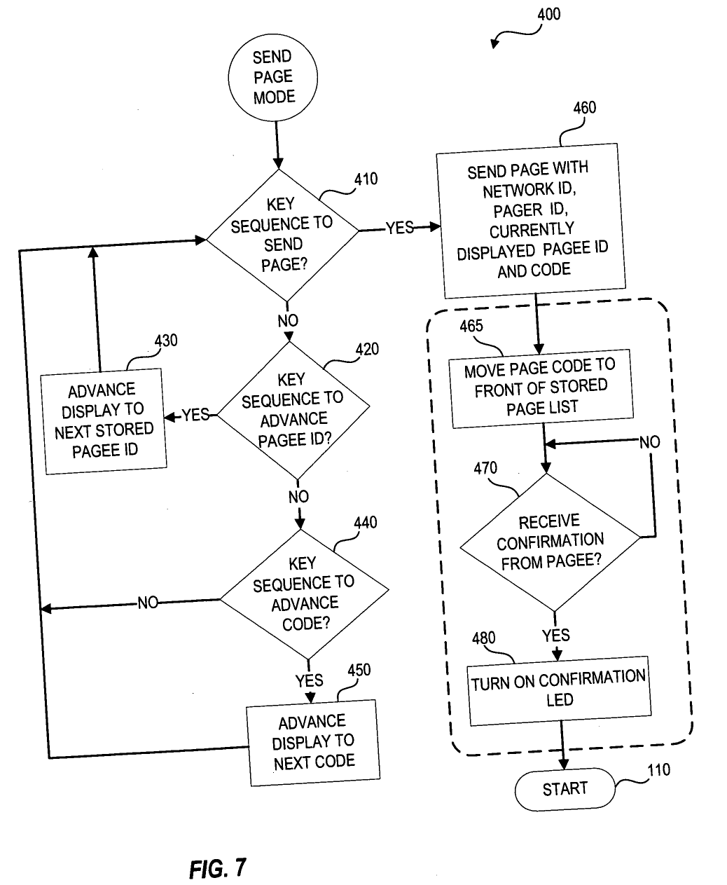

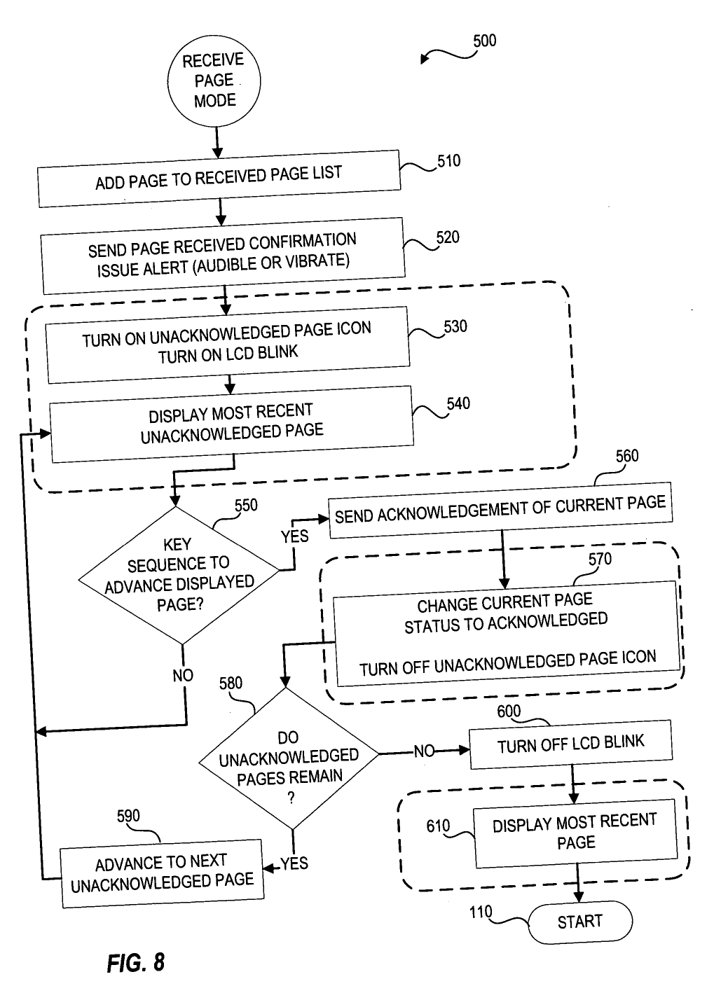

A transceiver 16 transmits data from pager 10(1) and receives data to pager 10(1), via an antenna 18. Display 20, controlled by processor 14, displays data (see, e.g., FIG. 2 and FIG. 4) to the user. For example, display 20 may indicate (1) information of one or more received pages (see FIG. 8); (2) information of a page being composed for sending (see FIG. 7); (3) an indication that pager 10(1) is operating in repeater mode (see FIG. 6); (4) information of an ID being composed while pager 10(1) is in learn mode (see FIG. 5); (5) an indication that a page is pending (e.g., as in “page indicator” of FIG. 2); and/or (6) current time and/or date information. Display 20 may operate in a static mode, such that information displayed on display 20 does not change unless forced by an event (such as receipt of a page or a user operating buttons of pager 10(1)), or it may operate in a dynamic mode, with display 20 or parts thereof flashing to indicate significance of some piece of information (such as a received page or a low battery condition), or it may sequence through multiple screens of information (such as alternating between page information and date/time information.) Display 20 may be, for example, an LCD or LED display.

Pager 10(1) optionally includes DIP switches 15 that communicate with processor 14. DIP switches 15 may be used, for example, to provide network information to processor 14 so that processor 14 can encode the network information into transmitted pages, and only other 2-way pages with the same network information will receive the pages, so that multiple networks of pagers can operate in one area without interfering with each other.

A power source 32 may power pager 10(1); power source 32 may include, for example, one or more AAA batteries. Pager 10(1) optionally includes an input power socket 34 and/or battery contacts 36 for recharging power source 32 and/or for operating pager 10(1) from an external power source. Pager 10(1) optionally includes an audio output device 28 and/or a vibrator 30 that can generate one or more signals to alert the user to an incoming page. Pager 10(1) optionally includes a computer interface port 37 for rapid setup of ID 27 and stored data 31 in memory 26. Pager 10(1) optionally includes a positioning element 38 that may be, for example, a belt clip, a key ring or a stand.

In one embodiment, a 2-way pager 10 (as exemplified by pager 10(1), FIG. 1 and pager 10(2), FIG. 2) operates in a localized area where certain individual pagers 10 act as repeaters to cover a desired range that is larger than the localized area. The use of pagers 10 as repeaters may for example provide cost savings, particularly if their range is only about 200 feet. The use of one or more 2-way pagers as repeaters thus creates a network that does not require sophisticated towers and antennas to span large distances.

In one embodiment, a 2-way pager 10 conveys the ID of the person(s) sending the page, the ID of the pager 10 belonging to the person(s) being paged (hereinafter known as the pagee) and an additional short code, rather than sending numeric, text or voice messages (although numeric, text and voice messages may also be conveyed by pager 10). In one example, a page is created by selecting the ID of the pagee's pager 10 (“pagee ID”) and a code (“page code”) that may follow a convention adopted by the pager and the pagee; the sent page also includes the ID of the pager 10 that sends the page (“pager ID”). For example, pager IDs and pagee IDs may be a user's initials or other cipher representing a user of pager 10, and page code may be a location where the pagee is expected to go, an activity the pagee is expected to perform or a situation the pagee is to be alerted to. The use of page codes thus supplants other, more complicated methods of communicating such as keying in a phone number or a text message, although in some embodiments phone numbers and text messages may also be sent by a 2-way pager 10. Furthermore, the pagee may be selected from a list of pagee IDs stored in memory 26; the ability to select both pagee ID and page code from a limited number of available codes provides fast and efficient paging. In one embodiment, a 2-way pager 10 may initially store a list of all possible codes in an initial order. When a page containing a given code is sent, the list is rearranged by taking the code that was in the sent page out of the initial order and placing it at the front of the list. Over time, as certain codes are paged more often than others, the list is reordered to a list that tends to have the most frequently paged codes at the front of the list, and the least frequently paged codes at the end of the list. When a page is composed for sending on a 2-way pager 10, a portion of display 20 shows the pagee ID and page code to be sent; when the page is received by another 2-way pager 10, the corresponding portion of display 20 shows the pager ID and the page code. As described in more detail below, a 2-way pager 10 may include one or more of the following features:
Each 2-way pager 10 has an ID to identify a user and/or a group of users. The ID of a 2-way pager 10 sending a page is called the pager ID, while the ID of a 2-way pager 10 that receives the page is called the pagee ID.
Each page may contain information such as a network ID, a pager ID, a pagee ID, and/or a page code signifying information to be communicated to the pagee. Each page may optionally include time and/or date information.
A 2-way pager 10 that receives a page may display a pager ID (an ID of a 2-way pager 10 that sent the page) and a page code entered by the user that sends the page.
A 2-way pager 10 that sends a page may display confirmation that the page was received.
A 2-way pager 10 that sends a page may display confirmation that the 2-way pager receiving the page has displayed the sent page.
A number of 2-way pagers 10 within one local network is limited only by number of characters used for the ID 27 stored in memory 26 of each 2-way pager 10.
A number of characters used to store and display IDs and page codes may be from 2 to 10 characters.
2-way pager 10 may generate an audio tone (e.g., a beep), a vibration and/or visual indications of events such as, for example, receipt of a page, confirmation of a sent page being received and/or displayed.
2-way pager 10 may automatically send a page received confirmation message to the sending 2-way pager 10 to indicate that the page was successfully received. The confirmation message includes the same information as the page, and additional information indicating that the message is a confirmation message (so that confirmation messages are not erroneously interpreted as new pages).
Sending 2-way pager 10 may retransmit a page if a page receive confirmation is not received within a designated time.
2-way pager 10 may sends a displayed acknowledgement message to the sending 2-way pager when a page is displayed on display 20 for the first time.
A user may display a page by pressing a designated button on 2-way pager 10.
2-way pager 10 may store a list of received pages and may store status of each page as acknowledged or unacknowledged.
2-way pager 10 may flash information such as the pager's ID and/or code on the display when scrolling through received pages. Flashing may stop when a given page is viewed, or when all received pages have been acknowledged.
2-way pager 10 has a small size.
2-way pager 10 may have a clip that stands the pager on a flat surface and/or loops around a belt.
2-way pager 10 may have a range of 100-200 feet (without extended transmission via a repeater).
DIP switch settings may allow assignment of a network code to 2-way pager 10, allowing different local networks to be co-located; DIP switch settings may also allow a 2-way pager 10 to differentiate learning its own ID from learning a pagee ID in a learn mode.
2-way pager 10 may indicate the presence of one or more unacknowledged pages.
2-way pager 10 may be configured to operate as a repeater.
2-way pager 10 may have rechargeable battery contacts to allow rechargeable batteries to be installed and charged.
2-way pager 10 may have a socket to allow it to be powered and/or to allow charging of batteries from an external power supply.
2-way pager 10 may have a port for connection with external devices for rapid setup (e.g., pager ID setup and importation of pagee ID and page code lists).

To send a page, a user may select (a) a pagee ID from a list of pagee IDs to be paged and/or (b) a page code from a list of page codes that is stored within memory 26 of a 2-way pager 10. The use of stored lists of pagee IDs and page codes may make it unnecessary for a user to use a complicated user interface to key in phone numbers or other text information. The user may press, for example, a page button 22(3) (see FIG. 2A) to send the page. The sent page may specify the ID of the sending pager, the selected pagee ID, and the selected page code, and may also specify a network ID of the sending pager (as configured by DIP switches 15, FIG. 1 and FIG. 2) and date/time information of the sending pager. The page code may indicate an office where the pagee is to meet the user, for example, or it may indicate an action to be performed by the pagee.

When a 2-way pager 10 receives a page, it first determines whether the page is already the last entry in a list of received pages that is stored (e.g., in memory 26). If the received page is already the last entry in the list of received pages it is ignored, otherwise it is added to the list of received pages, and the user is alerted (e.g., by output of audio device 28 or vibrator 30).

In an illustrative example of operation, a doctor's office may have ten employees, each with a 2-way pager 10 that allows paging from any employee to any other employee within a local 2-way network. Each 2-way pager 10 processes and stores received pages (e.g., as stored data 31 within memory 26 of each pager 10) for future addressing use, thereby eliminating the need to key in pagee IDs or page codes. A doctor may select the pagee ID of an employee he wants to meet at his office. The doctor need only press a few buttons 22 on pager 10 to select a pagee ID of the employee and a page code that corresponds to “go to the office,” and then to press the page button 22(3) (see FIG. 2A), to summon the employee to the office. The 2-way pager 10 of the employee receives the ID of the doctor that sent the page, and the page code that corresponds to “go to the office.” In this example, operation of each 2-way pager 10 is very simple since there is no need to enter an area code, a phone number or a text message.

FIG. 2A and FIG. 2B show front and back views, respectively, of a 2-way pager 10(2). Pager 10(2) may include some or all of the features of pager 10(1) (FIG. 1), with like numerals being used where applicable; specific examples of generic features are identified by numerals in parenthesis (e.g., buttons 22(1)-22(3) are specific examples of buttons 22).

In FIG. 2A, display 20 of pager 10(2) includes LCD numerals 40(1)-40(4) and LCD icons 42(1)-42(4). LCD numerals 40(1) and 40(2) may display an ID, and LCD numerals 40(3) and 40(4) may display a page code, as discussed above. When pager 10(2) receives a page, LCD icon 42(1) may indicate that the page has been received but not yet acknowledged. LCD icon 42(2) may indicate whether pager 10(2) is functioning as a repeater (see FIG. 4 and FIG. 6). LCD icon 42(3) may indicate a condition of power supply 32 (FIG. 1); a visually “filled” portion 44 may indicate, for example, a relative amount of charge in batteries 32(1) and 32(2) (described below). LCD icon 42(4) may indicate when pager 10(2) is in a “Learn” mode (see FIG. 4 and FIG. 5). All of LCD numerals 40(1)-40(4) and LCD icons 42(1)-42(4) may be controlled by a processor (e.g., processor 14, FIG. 1). Display 20 may be large enough, for example, that LCD numerals 40(1)-40(4) and LCD icons 42(1)-42(4) may be read at a distance, enabling a user to see contents of a page when pager 10(2) is at belt level without having to move pager 10(2). In an alternative embodiment, a display 20 may have more digits and/or icons than shown in display 20(1), for example, a display 20 may have certain digits that typically display ID and page code information, and other digits that display time and/or date information

Printed (or raised or embossed) indicia such as, for example, indicia 46(1)-46(5) may be present to help a user understand the meaning and function of features of pager 10(2); such indicia may also be customized for a given application. For example, indicia 46(2) that reads as “CODE” in FIG. 2A may read as “ROOM” for a pager 10 used in a doctor's office, as “TABLE” for a pager 10 used by a server or manager in a restaurant, or as “DISH” for a pager 10 used by a short order cook in a restaurant. Button 22(1) is an “ID advance” button; button 22(2) is a “Code advance” button; button 22(3) is a “Page” button; exemplary functions of these buttons are explained below in connection with FIG. 4 through FIG. 8. Input power socket 34, battery contacts 36 and computer interface port 37 are also shown.

In FIG. 2B, positioning element 38(1) is for example a belt clip, however other positioning elements such as a stand may be utilized. Two batteries 32(1) and 32(2) are shown in dashed outline as they are hidden, in this view, behind a battery cover 48. Also hidden behind battery cover 48, and partially beneath batteries 32(1)-32(2), are four DIP switches 15 that may be used to define a network that pager 10(2) belongs to, as discussed in connection with FIG. 1, and/or (2) to change the ID of a pager, as discussed below in connection with FIG. 5. Pager 10(2) forms holes 33 over audio device 28 that is otherwise hidden within pager 10(2). Vibrator 30 is also shown as hidden within pager 10(2). Input power socket 34, battery contacts 36 and computer interface port 37 are also shown.

Variations in number, position and type of elements shown in FIG. 2A and FIG. 2B are within the scope of the current disclosure. For example, although FIG. 2A shows two LCD numerals corresponding with ID digits and two LCD numerals corresponding with code digits, different numbers and types of numerals may be used, the ID and code digits may be different in numbers or be in separate displays, and separate displays may be of differing types. Different numbers of buttons may be used and may correspond with different functions than the exemplary functions described in connection with FIG. 4 through FIG. 8.

When pager transmission range is unimpeded by intervening objects, each 2-way pager 10 may have a range of about 200 feet. A 2-way pager 10 may also be configured to operate as a repeater, meaning that a pager so configured re-transmits any page that it receives, instead of acknowledging and displaying the page (see FIG. 4 and FIG. 6). A pager 10 configured as a repeater extends the range of the local network; when one or more 2-way pagers 10 at appropriate locations are repeaters, the range of the local network may be extended to allow 2-way pagers 10 to communicate beyond their individual communication range (i.e., beyond 200 feet, see FIG. 3). Repeaters may also be used to overcome pager communication coverage problems (caused for example by shapes of and/or materials used in certain buildings). A pager 10 configured as a repeater treats a confirmation message like any other incoming page; that is, it repeats the confirmation message so as to relay it back to the sending 2-way pager 10.

FIG. 3 illustrates an exemplary embodiment of a local network, showing how 2-way pagers 10(3)-10(11) may communicate with each other. Each of pagers 10(3)-10(11) has a range indicated by arrows 50 (not all arrows 50 are labeled, for clarity of illustration). It can be seen, for example, that pager 10(3) can communicate directly with pagers 10(4), 10(6) and 10(7), and that pager 10(10) can communicate directly with pagers 10(6), 10(7), 10(8), 10(9) and 10(11).

It can also be seen in the embodiment of FIG. 3 that pager 10(7) can communicate directly with any other pager 10(3)-10(11). Therefore, if 2-way pager 10(7) acts as a repeater, any of pagers 10(3)-10(11) can communicate with each other through 2-way pager 10(7). For example, 2-way pager 10(7), acting as a repeater, allows pager 10(3) to communicate with any of pagers 10(5), 10(8), 10(9), 10(10) and 10(11). When pager 10(3) communicates with pager 10(8), for example, the steps involved are: (1) Pager 10(3) sends a page; (2) pager 10(7) detects the page and repeats the page; (3) pager 10(8) detects the page, alerts a user of pager 10(8) and sends a first confirmation that the page was detected; (4) pager 10(7) detects the first confirmation and repeats it, (5) pager 10(3) detects and displays the first confirmation; (6) the user of pager 10(8) presses, for example, the “ID advance” button 22(1) to confirm displaying the page, and pager 10(8) sends a second confirmation acknowledging that the user has displayed the page; (7) pager 10(7) detects the second confirmation and repeats it; and (8) pager 10(3) detects and displays the second confirmation.

2-way pagers may transmit and receive pages using one or more frequencies within the frequency range 150 MHz to 900 MHz, although other frequencies may be used in certain cases.

A transmission collision occurs when two users of 2-way pagers 10 press the page button at about the same time, so that the resulting transmissions overlap; the pages transmitted may not be received correctly, in which case a receiving 2-way pager 10 will not respond to the page. The 2-way pagers 10 that originally sent the pages thus do not receive a ‘receive confirm’ message for the page, and in one embodiment, may wait for a random delay period and re-transmit the page. Also, if the 2-way pager does not indicate a read acknowledge for the page, the user may also re-send the page.

In one embodiment, a 2-way pager may indicate that a page is received by destination 2-way pager by displaying an icon on the display. This does not indicate that the user of the destination 2-way pager has read the page, but that it was received by the intended 2-way pager and is stored in its list of pages.

FIG. 4 is a flowchart of one exemplary process 100 of 2-way paging; process 100 is for example implemented by a 2-way pager 10. Process 100 (and other modes illustrated in FIG. 5 through FIG. 8) may be executed, for example, by processor 14 of 2-way pager 10. Process 100 (and other modes illustrated in FIG. 5 through FIG. 8) includes decision points that may accept a “key sequence” from a user of 2-way pager 10(1); it is appreciated that while exemplary sequences of buttons (e.g., buttons 22, FIG. 1 or buttons 22(1)-22(3), FIG. 2A) are listed in some cases, such key sequences are exemplary only, that is, a 2-way pager 10 may accept sequences of buttons 22 as input even if they are different from those listed. Certain steps in process 100 (and other modes illustrated in FIG. 5 through FIG. 8) are enclosed within dashed rectangles to indicate that the steps so enclosed are optional to functionality of a 2-way pager 10.

Process 100 begins at a Start step 110. Step 120 accepts a key sequence to enter a learn mode 200: if the appropriate key sequence is entered by the user, process 100 enters learn mode 200 (see FIG. 5); otherwise process 100 enters step 130. Step 130 accepts a key sequence to enter a repeater mode 300: if the appropriate key sequence is entered by the user, process 100 enters repeater mode 300 (see FIG. 6); otherwise process 100 enters step 140.

Step 140 accepts a key sequence to toggle an alert mode of 2-way pager 10 between an audible mode and a vibrate mode. A given alert mode (audible mode or vibrate mode) of 2-way pager 10 may be stored in memory 26 so that the pager can come back up in the same mode even if powered down, or the alert mode may be determined by an active logic state while powered on, reverting to a default alert mode when the pager powers down. In step 140, if the appropriate key sequence is entered by the user, step 150 changes the current alert mode from audible to vibrate or from vibrate to audible (and may optionally store the current alert mode in memory 26), otherwise process 100 enters step 160.

Step 160 checks whether a confirmation has been received. If so, a confirmation LED (e.g., LED 24) is turned off; otherwise process 100 enters step 180. Step 180 checks whether a page has been received: if so, process 100 enters step 190, otherwise process 100 enters a send page mode 400 (see FIG. 7). Step 190 checks to see whether a received page is valid; for example, whether the format of the received page is valid (e.g., not corrupted by a transmission collision) and that the received page has a network ID that is the same as the 2-way pager 10 receiving the page (e.g., it is a page for the correct network, not a different network). If the received page is valid, process 100 enters a receive page mode 500, otherwise process 100 returns to step 110.

Dashed lines connecting learn mode 200, repeater mode 300, send page mode 400 and receive page mode 500 with Start step 110 indicate that each of these modes returns to Start step 110; the logic flows that effect these returns are illustrated in FIG. 5 through FIG. 8.

FIG. 5 is a flowchart of learn mode 200 of 2-way pager 10. Step 210 of learn mode 200 turns on a “Learn” icon (e.g., LCD icon 42(4), FIG. 2A) and resets ID digits to beginning characters of an ID digit sequence. For example, an ID digit sequence may include values of blank, 0 through 9 and/or A through Z in any order; step 210 resets each of the ID digits to whatever value is considered the first in the digit sequence. Step 220 scrolls the value of the first ID digit through the digit sequence in response to an appropriate key sequence (e.g., use of ID advance button 22(1), FIG. 2A). Step 230 accepts a key sequence that changes the digit being scrolled to the second (or subsequent) digit; in the absence of such a key sequence, learn mode 200 reverts to step 220. Step 240 scrolls the value of the second (or subsequent) ID digit through the digit sequence in response to an appropriate key sequence (e.g., use of ID advance button 22(1), FIG. 2A). Step 250 accepts a key sequence that indicates a user wishes to complete learn mode; in the absence of such a key sequence, learn mode 200 reverts to step 240. Step 260 checks the configuration of the 2-way pager 10's DIP switches (e.g., DIP switches 15, FIG. 2B). If the DIP switches are set to a configuration that corresponds with a pager ID learn mode, learn mode 200 enters step 270 that stores the currently displayed ID as the pager ID. If the DIP switches are set to any other configuration (e.g., a network configuration as discussed in connection with FIG. 2B), learn mode 200 enters step 280 that stores the currently displayed ID as a pagee ID. After either of steps 270 or 280, learn mode 200 enters step 290 that turns off the “Learn” icon and turns on a confirmation LED (e.g., LED 24, FIG. 2A). After step 290, 2-way pager 10 exits learn mode and returns to step 110 of process 100 (FIG. 4).

FIG. 6 is a flowchart of repeater mode 300 of 2-way pager 10. Step 310 of repeater mode 300 turns on a repeater icon (e.g., LCD icon 42(2), FIG. 2A). Step 320 accepts a key sequence to exit the repeater mode (e.g., pressing both ID advance button 22(1) and Code advance button 22(2) (FIG. 2A) simultaneously). If such a sequence is received, repeater mode 300 enters step 330 that turns off the repeater icon, then returns to step 110 of process 100 (FIG. 4). If the key sequence to exit repeater mode is not received in step 320, step 340 checks to see if a page has been received. If no page has been received, repeater mode 300 returns to step 320. If a page is received, step 350 checks to see if the page is valid. If the page is not valid (e.g., it is corrupted by a transmission collision, or it is a page for a different network), repeater mode 300 returns to step 320. If the page is valid, step 360 repeats the page. It will be appreciated when a 2-way pager 10 is in repeater mode 300, confirmations are repeated in the same manner as an original page. An optional step 370 waits for a predetermined delay and repeats the page; step 370 may increase chances of a page (or a confirmation) being successfully relayed in case a transmission error disrupts the first repetition of the page, or in case an intended pagee (or pager intended as recipient of a confirmation) is temporarily out of range. After step 370 (or step 360, if step 370 is omitted) repeater mode 300 returns to step 320.

FIG. 7 is a flowchart of send page mode 400 of 2-way pager 10. Send Page mode 400 allows a user of 2-way pager 10 to compose a page by selecting information displayed on display 20, then sending the page. Step 410 of send page mode 400 accepts a key sequence (e.g., Page button 22(3), FIG. 2A) to send a page that is currently displayed on display 20. If the key sequence is received, send page mode 400 enters step 460, otherwise send page mode 400 enters step 420, which accepts a key sequence (e.g., ID advance button 22(1), FIG. 2A) to advance a pagee ID displayed in display 20. If the key sequence to advance a pagee ID is received in step 420, send page mode 400 enters step 430, which advances the ID digits of display 20 to display another stored pagee ID in the pagee ID list (as discussed in connection with FIG. 1), then returns to step 410. If the key sequence to advance a pagee ID is not received in step 420, send page mode 400 enters step 440, which accepts a key sequence (e.g., Code advance button 22(2), FIG. 2A) to advance a page code displayed in display 20. If the key sequence to advance a page code is received in step 440, send page mode 400 enters step 450, which displays another page code stored in the code list (as discussed in connection with FIG. 1) in display 20, then returns to step 410.

Once a user is satisfied with a page displayed in display 20 and presses the appropriate key sequence to send a page, send page mode 400 enters step 460, which transmits a page that includes a network ID (as set by DIP switches 15, FIG. 1 and FIG. 2B), the pager ID (e.g., the ID 27 (FIG. 1) stored in the sending 2-way pager 10), the currently displayed (in display 20) pagee ID (e.g., the ID 27 (FIG. 1) stored in the 2-way pager 10 intended to receive the page) and page code. The page may also, optionally, include date and/or time information of the sending 2-way pager 10. An optional step 465 moves the page code of the transmitted page to the front of a stored page code list of 2-way pager 10 (as discussed in connection with FIG. 1). Optional step 470 waits for a confirmation to be received, and when a confirmation is received optional step 480 turns on a confirmation LED of the sending 2-way pager 20. After step 460 and/or optional steps 470 and 480, send page mode 400 returns to step 110 of process 100 (FIG. 4).

FIG. 8 is a flowchart of receive page mode 500 of 2-way pager 10. Step 510 of receive page mode 500 adds a newly received page (which was confirmed as valid in step 190, process 100) to the received page list of 2-way pager 10. An optional step 520 sends a page received confirmation and issues an alert which may be audible (e.g., a beep, or an audible signal that can convey information about the page code by varying pitch, tone, type and/or sequence of sounds) or tactile (e.g., the pager may vibrate). An optional step 530 turns on an unacknowledged page icon (e.g., LCD icon 42(1), FIG. 1) and places part or all of display 20 in a blinking mode. Step 540 displays the most recent unacknowledged page in display 20. Step 540 accepts a key sequence (e.g., ID advance button 22(1), FIG. 2A) to advance the displayed page. If the key sequence to advance the displayed page is received, receive page mode 500 enters step 560, otherwise it reverts to step 540. Step 560 sends an acknowledgement of the current page, and an optional step 570 changes the current page status to “acknowledged” in the received page list. Step 580 reviews the received page list to determine whether “unacknowledged” pages remain in the received page list; if so, step 590 displays the next unacknowledged page in the list, and receive page mode 500 reverts to step 540. If no “unacknowledged” pages remain in the received page list, an optional step 600 turns off the blinking mode of display 20, an optional step 610 displays the most recent page, and receive page mode returns to step 110 of process 100 (FIG. 4).

Since certain changes may be made in the above methods and systems without departing from the scope of the disclosure herein, one intention is that all matter contained in the above description or shown in the accompanying drawings be interpreted as illustrative and not in a limiting sense. By way of example, those skilled in the art should appreciate that the 2-way pager described herein may be constructed, connected, arranged, and/or combined in ways that are equivalent to what is shown.

### REFERENCES

The following patents are incorporated herein by reference:

| U.S. Pat. No. | Issue month, year | Inventors |
|---|---|---|
| 4041389 | August, 1977 | Oades. |
| 4198600 | April, 1980 | Oguchi et al. |
| 4284848 | August, 1981 | Frost. |
| 4556865 | December, 1985 | Fukagawa et al. |
| 4599598 | July, 1986 | Komoda et al. |
| 4701935 | October, 1987 | Namiki. |
| 4789933 | December, 1988 | Chen et al. |
| 5023930 | June, 1991 | Leslie |
| 5133001 | July, 1992 | Bohm. |
| 5252979 | October, 1993 | Nysen. |
| 5265150 | November, 1993 | Helmkamp et al. |
| 5321736 | June, 1994 | Beasley. |
| 5408681 | April, 1995 | Ressler et al. |
| 5424859 | June, 1995 | Uehara et al. |
| 5437055 | July, 1995 | Wheatley, III. |
| 5537637 | July, 1996 | Sugita et al. |
| 5577265 | November, 1996 | Wheatley, III. |
| 5752163 | May, 1998 | Robinson |
| 5770970 | June, 1998 | Ikeda et al. |
| 5802452 | September, 1998 | Grandfield et al. |
| 5809398 | September, 1998 | Moberg et al. |
| 5812933 | September, 1998 | Niki. |
| 5815108 | September, 1998 | Terk. |
| 5832364 | November, 1998 | Gustafson. |
| 5832365 | November, 1998 | Chen et al. |
| 5854611 | December, 1998 | Gans et al. |
| 5995804 | November, 1999 | Rootsey et al. |

What is claimed is:

1. A 2-way pager, comprising:
a transceiver for transmitting a sent page and for receiving a received page;
a user interface for displaying information of the received page and for inputting information of the sent page;
memory configured to store a list of pagee IDs and a list of page codes; and
a processor responsive to the user interface and the memory for associating a selected pagee ID with a selected page code to compose the sent page.

2. The pager of claim 1, the user interface comprising one or more buttons.

3. The pager of claim 1, the user interface consisting of three buttons, an LCD display, and an LED.

4. The pager of claim 1, further comprising DIP switches for configuring a network ID that is included in the sent page, the processor responsive to ignore a received page that does not include a corresponding network ID.

5. The pager of claim 1, wherein reception of the received page is automatically confirmed, the user interface comprising a device for indicating reception of the received page.

6. The pager of claim 1, wherein the received page may be acknowledged by a user of the pager.

7. The pager of claim 1, the user interface further comprising a page acknowledged indicator to indicate that the sent page is acknowledged.

8. The pager of claim 1, wherein the user interface displays an indication of the received page and acknowledgment of the sent page.

9. The pager of claim 1, wherein the user interface has a large display that may be read while attached to a belt or other article of clothing.

10. The pager of claim 1, further including repeater functionality that comprises repeating each sent page and each page confirmation.

11. The pager of claim 1, further including a computer interface for setting up the list of pagee IDs and the list of page codes.

12. The pager of claim 1, the memory comprising a nonvolatile memory.

13. The pager of claim 1, further comprising functionality for sending and receiving text messages.

14. The pager of claim 1, further comprising functionality for generating a time signal and for displaying a current time.

15. A method of two-way paging, comprising
accepting a key sequence to compose information of a page on a first pager,
sending the page from the first pager to a second pager, the page comprising information of a network ID, a pager ID, a pagee ID and a page code,
receiving the page at the second pager,
validating that the second pager is configured for the network ID of the page, and
sending a confirmation from the second pager to the first pager to confirm that the page was received.

16. The method of claim 15 additionally comprising displaying a pagee ID and a page code on the first pager, the step of accepting comprising scrolling the pagee ID and the page code on a display in response to buttons pressed on the first pager.

17. The method of claim 15, the step of sending comprising sending the page from the first pager to a third pager configured as a repeater, and the third pager sending the page to the second pager.

18. A software product comprising instructions, stored on computer-readable media, wherein the instructions, when executed by a computer, perform steps for two-way paging, comprising:
accepting a key sequence to compose information of a page on a first pager,
sending the page from the first pager to a second pager, the page comprising information of a network ID, a pager ID, a pagee ID and a page code,
receiving the page at the second pager,
validating that the second pager is configured for the network ID of the page, and
sending a confirmation from the second pager to the first pager to confirm that the page was received.

19. The software product of claim 18, further comprising instructions for displaying a pagee ID and a page code on the first pager, the step of accepting comprising scrolling the pagee ID and the page code in response to buttons pressed on the first pager.

20. The software product of claim 18, further comprising instructions for configuring a pager as a repeater that can repeat a page from another pager.

21. The method of claim 18, further comprising instructions for configuring a pager in each of a learn mode, a repeater mode, a send page mode and a receive page mode.
